(19) United States
(12) Patent Application Publication
(10) Pub. No.: US 2011/0061983 A1
(43) Pub. Date: Mar. 17, 2011

(54) ROTATION TRANSMISSION DEVICE

(76) Inventors: Takanobu Sato, Shizuoka (JP); Koji Akiyoshi, Shizuoka (JP); Takahide Saito, Shizuoka (JP)

(21) Appl. No.: 12/991,914

(22) PCT Filed: Jun. 1, 2009
(86) PCT No.: PCT/JP2009/059975

§ 371 Date: Nov. 10, 2010

(30) Foreign Application Priority Data
Jun. 4, 2008 (JP) 2008-146790
Jun. 9, 2008 (JP) 2008-150192
Jun. 16, 2008 (JP) 2008-156623

(51) Int. Cl. F16D 43/00; F16D 27/102

(52) U.S. Cl. 192/38

(57) ABSTRACT

A rotation transmission device is provided which has a minimum play in the rotational direction, which is reliable by preventing the rollers from erroneously engaging during idling, and which has high torque capacity. A control retainer 19A and a rotary retainer 19B are mounted between an outer race 11 having a cylindrical surface 17 on its inner periphery and an inner race 12 having cam surfaces 18 on its outer periphery. An opposed pair of rollers 25 are mounted in each of pockets 24 defined between pillars 21 and 23 of the respective retainers 19A and 19B. A presser member 26 is also mounted in each pocket 24 which biases the pair of rollers 25 away from each other while pressing the rollers against the cam surface 18. A plurality of torque cams 40 are provided between flanges 20 and 22 of the control retainer 19A and the rotary retainer 19B. When the control retainer 19A is moved toward a rotor 52 by the actuation of an electromagnetic clutch 50, the torque cams 40 rotate the control retainer 19A and the rotary retainer 19B in the direction in which the circumferential width of the pockets 24 decreases, thereby disengaging the opposed pairs of rollers 25. When the control retainer 19A is moved away from the rotor 52, the control retainer 19A and the rotary retainer 19B are rotated relative to each other in the direction in which the circumferential width of the pockets 24 increases under the biasing force of the presser members 26, thereby engaging the rollers 25. While the inner race 12 is idling, the presser members 26 prevent the rollers 25 from moving radially outwardly, thereby preventing erroneous engagement of the rollers 25.

### TECHNICAL FIELD

This invention relates to a rotation transmission device for selectively transmitting and not transmitting power.

### BACKGROUND ART

Patent document 1 discloses a conventional rotation transmission device mounted on an FR (front-engine rear-drive)-based 4-wheel drive vehicle for selectively transmitting and not transmitting driving force to the front wheels as auxiliary drive wheels.

The rotation transmission device disclosed in Patent document 1 includes a two-way clutch disposed between a large-diameter portion formed on an input member and an outer race provided around the large-diameter portion, and an electromagnetic clutch provided in juxtaposition with the two-way clutch for selectively engaging and disengaging the two-way clutch. When the two-way clutch is engaged, the input member is coupled to the output member and torque is transmitted between the input member and the output member.

The two-way clutch comprises a cylindrical surface formed on the inner periphery of the outer race, cam surfaces formed on the outer periphery of the large-diameter portion of the input member and defining, in cooperation with the cylindrical surface, wedge-shaped spaces having narrow circumferential ends, and engaging elements in the form of rollers disposed between the respective cam surfaces and the cylindrical surface. When a retainer retaining the engaging elements rotates relative to the input member, the engaging elements are adapted to engage the cylindrical surface and the cam surfaces. A switch spring is mounted between the input member and the retainer to bias the retainer toward neutral position where the engaging elements disengage from the cylindrical surface and the cam surfaces.

The electromagnetic clutch comprises an armature rotationally fixed to but axially movable relative to the retainer, a rotor axially facing the armature, an electromagnet axially facing the rotor, and a separation spring biasing the armature away from the rotor. When the electromagnet is energized, the armature is pulled to the rotor, so that the armature, which is now coupled to the outer race, and the input member rotate relative to each other, which in turn brings the engaging elements into engagement with the cylindrical surface and the cam surfaces.

In this two-way clutch, since each roller is moved from the neutral position, where the roller is located in the wide portion of the wedge-shaped space, and wedged into a narrow end of the wedge-shaped space by rotating the input member and the retainer relative to each other, there exists a large play in the rotational direction.

With torque being transmitted between the outer race and the input member in one direction, in order to change the direction in which the torque is transmitted, the retainer has to be turned from the position where each roller is wedged in one of the narrow ends of the wedge-shaped space to the position where the roller is wedged into the other narrow ends of the wedge-shaped space. Thus, it was difficult to sufficiently quickly change the direction in which torque is transmitted.

In order to solve these problems, Patent document 2 discloses a two-way roller clutch in which a plurality of rollers are non-equidistantly arranged such that one of any adjacent pair of rollers are located at one circumferential end of the corresponding wedge-shaped space while the other of the adjacent pair is located at the other circumferential end of the corresponding wedge-shaped space.

### PRIOR ART DOCUMENTS

### Patent Documents

Patent document 1: JP Patent Publication 2005-249003A
Patent document 2: JP Patent Publication 2003-262238A

### SUMMARY OF THE INVENTION

### Object of the Invention

With the two-way roller clutch disclosed in Patent document 2, although play in the rotational direction decreases, there still remains play in the rotational direction. Also, because the clearances between the rollers and the outer ring cylindrical surface and between the rollers and the inner race cam surfaces are small, the rollers may erroneously engage while the two-way clutch is idling. Thus, reliability of operation is low during idling.

While torque is being transmitted between the outer race and the inner race, only half of the plurality of rollers are in engagement, while the remaining half of the rollers are not. Thus, torque capacity is small.

An object of the present invention is to provide a rotation transmission device which has a minimum play in the rotational direction, which is reliable by preventing the rollers from erroneously engaging during idling, and which has high torque capacity.

### Means to Achieve the Object

In order to achieve this object, the present invention provides a rotation transmission device comprising an outer race having a closed end provided with an output shaft, an input shaft, an inner race mounted on the input shaft and in the outer race, the outer race and the inner race being rotatable relative to each other, wherein a cylindrical surface is formed on one of an inner periphery of the outer race and an outer periphery of the inner race, and a plurality of circumferentially spaced apart cam surfaces are formed on the other of the inner periphery of the outer race and the outer periphery of the inner race, the cylindrical surface and each of the cam surfaces defining a wedge-shaped space therebetween which narrows toward circumferential ends thereof, a control retainer and a rotary retainer rotatably mounted between the outer race and the inner race, wherein the control retainer comprises a flange and a plurality of pillars formed on a radially outer portion the flange, wherein the rotary retainer has the same shape as the control retainer, wherein the flanges of the respective retainers axially face each other, and wherein the flange of the rotary retainer faces one side surface of the inner race, with the pillars of one of the retainers disposed between the respective circumferentially adjacent pillars of the other of the retainers, thereby defining pockets between the respective circumferentially adjacent pillars of the respective retainers, the pockets facing the respective cam surfaces, a plurality of opposed pairs of rollers, each pair being received in one of the pockets, presser members received in the respective pockets and biasing the respective pairs of rollers away from each other while pressing the rollers against the outer periphery of the inner race, torque cams provided between opposed surfaces of the flange of the control retainer and the flange of the rotary retainer that are configured to rotate the retainers relative to each other in a direction in which a circumferential width of the pockets decreases when the control retainer moves in a direction in which the distance between the flange of the control retainer and the flange of the rotary retainer decreases, a retaining plate fixed to another side surface of the inner race and having a plurality of anti-rotation pieces on an outer periphery thereof for supporting the respective pillars of the retainers, thereby keeping the respective opposed pairs of rollers in neutral position, when the control retainer and the rotary retainer rotate relative to each other in the direction in which the circumferential width of the pockets decreases, and an actuator mounted on a torque transmission shaft connected to the inner race for axially moving the control retainer.

With this rotation transmission device, when the control retainer is moved by the actuator in the direction in which its flange moves toward the flange of the rotary retainer, the control retainer and the rotary retainer are rotated relative to each other in the direction in which the circumferential width of the pockets decreases by the action of the torque cams, so that the opposed pairs of rollers are pushed toward each other by the respective pillars of the control retainer and the rotary retainer, and disengage.

Thus, even when the inner race is rotating, its rotation is not transmitted to the outer race and the inner race idles. While the inner race is idling, the opposed pairs of rollers are prevented from being moved into narrow portions of the respective wedge-shaped spaces by the pillars of the control retainer and the rotary retainer. Also, since the opposed pairs of rollers are always pressed against the outer periphery of the inner race by the presser members, the rollers are never moved radially outwardly under centrifugal force.

If the rollers move radially outwardly under centrifugal force, they may contact the inner periphery of the outer race, which could in turn move the rollers into engaged position due to dragging torque acting on the rollers. But because the presser members prevent radially outward movement of the rollers, there will be no erroneous engagement of the rollers.

The presser members may each comprise a leaf spring bent in the shape of the letter W. Otherwise, the presser members may each comprise a cylindrical member, a pair of presser elements slidably supported by respective ends of the cylindrical member and having, respectively, inclined roller pressing surfaces facing the respective ones of each opposed pair of rollers, and a coil spring biasing the pair of presser elements against the respective ones of each opposed pair of rollers.

A single presser member may be provided between each opposed pair of rollers. Or alternatively, a plurality of such presser members may be arranged in a plurality of rows in the longitudinal direction of the rollers, between each opposed pair of rollers. With the latter arrangement, it is possible to prevent skew of the rollers.

With the inner race idling, when the actuator is actuated and the control flange is moved axially in the direction in which its flange moves away from the flange of the rotary retainer, the control retainer and the rotary retainer rotate relative to each other in the direction in which the circumferential width of the pockets increases under the biasing force of the presser members. This causes the opposed pairs of rollers to instantly wedge into the respective narrow portions of the wedge-shaped spaces. Thus torque in one direction is transmitted between the inner and outer races through one of each opposed pair of rollers, and toque in the opposite direction is transmitted through the other of each opposed pair of rollers.

The torque cams of the rotation transmission device according to this invention may each comprise an opposed pair of cam grooves formed in the respective opposed surfaces of the flange of the control retainer and the flange of the rotary retainer and circumferentially spaced from the cam grooves of the other toque cams, the cam grooves having a depth that decreases toward circumferential ends thereof, and a ball fitted in the opposed pair of cam grooves, the ball of each torque cam being configured to roll from shallow portions toward deep portions of the respective opposed pair of cam grooves, thereby rotating the retainers relative to each other in the direction in which the circumferential width of the pockets decreases, when the control retainer moves in the direction in which the distance between the flanges of the respective retainers decreases.

With this arrangement, when the control retainer is moved in the direction in which the flange of the control retainer moves toward the flange of the rotary retainer, the ball of each torque cam rolls from shallow to deep portions of the respective opposed pair of cam grooves, so that the control retainer and the rotary retainer rotate relative to each other in the direction in which the circumferential width of the pockets decreases.

In this arrangement, when the control retainer and the rotary retainer rotate relative to each other in the direction in which the circumferential width of the pockets increases, the ball of each torque cam rolls toward shallow portions of the respective opposed pair of cam grooves. At this time, if the control retainer and the rotary retainer rotate relative to each other with their axes inclined to each other, the distances between the cam grooves of the respective torque cams differ from each other, so that loads applied to the respective balls also differ from each other. In this state, any ball to which load is scarcely or not at all applied may circumferentially come out of the cam grooves from their shallow portions.

If this happens, the two-way roller clutch loses its function and the rotation transmission device cannot be reliably operated.

By mounting an elastic member between opposed surfaces of the flange of the rotary retainer and the inner race for biasing the flange of the rotary retainer toward the flange of the control retainer, the control retainer and the rotary retainer are always kept coaxial with each other.

Thus, loads are uniformly applied to the respective balls, which prevents separation of the balls while the control retainer and the rotary retainer are rotating relative to each other, which in turn allows normal operation of the two-way roller clutch at all times.

Further, by providing spherical stopper surfaces at the shallow ends of the cam grooves so as to extend along the outer periphery of the ball, it is possible to more reliably prevent separation of the ball.

A thrust needle bearing may be mounted between opposed surfaces of the elastic member and the inner race. With this arrangement, the rotary retainer can be smoothly rotated relative to the inner race, so that the two-way clutch can be operated more smoothly.

The actuator of the rotation transmission device according to this invention may be an electromagnetic clutch comprising an armature fixedly coupled to the pillars of the control retainer and slidably fitted on the outer periphery of the torque transmission shaft, a rotor supported by the torque transmission shaft and axially facing the armature, and an electromagnet axially facing the rotor and configured to pull the armature to the rotor when energized.

Alternatively, the actuator may be an electromagnetic clutch comprising an armature fixedly coupled to the pillars of the control retainer and slidably fitted on the outer periphery of the torque transmission shaft, a rotor supported by the torque transmission shaft and axially facing the armature, a permanent magnet for pulling the armature to the rotor against the biasing force of the presser members, and an electromagnet axially facing the rotor and configured to reduce the magnetic force of the permanent magnet to a level lower than the biasing force of the presser members.

When the electromagnetic coil is energized or deenergized after power has been transmitted between the inner race and the outer race in order to disengage the rollers, if there remains torque between the inner race and the outer race, the residual torque may prevent disengagement of the rollers. This makes it impossible to determine whether the rollers are in engagement or engagement only from the fact that the electromagnetic clutch is energized or deenergized.

Thus, in order to determine whether the rollers are actually disengaged, the rotation transmission device may further include a first rotation sensor assembly provided around the input shaft for detecting the rotation of the input shaft, and a second rotation sensor assembly provided around the output shaft for detecting the rotation of the output shaft.

With this arrangement, when the electromagnet is energized and deenergized and the rollers are supposed to be disengaged, if the rollers are actually not deenergized due to residual torque, since the input shaft and the output shaft rotate at the same speed, the first rotation sensor assembly and the second rotation sensor assembly generate identical rotation signals.

On the other hand, if the rollers are actually disengaged, since only the input shaft keeps rotating while the output shaft stops, a rotation signal is generated from the first rotation sensor assembly, while no rotation signal is generated from the second rotation sensor assembly.

Thus, it is possible to determine whether the rollers are actually disengaged based on whether there is a difference in rotation between the rotation signal generated from the first rotation sensor assembly and the rotation signal generated from the second rotation sensor assembly.

The rotation transmission device may include a first bearing rotatably supporting the input shaft and carrying the first rotation sensor assembly and a second bearing rotatably supporting the output shaft and carrying the second rotation sensor assembly. With this arrangement, it is possible to mount the first rotation sensor assembly and the second rotation sensor assembly simultaneously when mounting the first bearing and the second bearing. Thus, the rotation transmission device can be assembled easily.

Each of the first rotation sensor assembly and the second rotation sensor assembly may comprise a magnetic encoder and a Hall IC for detecting changes in magnetic field due to rotation of the magnetic encoder and generating a digital signal.

Alternatively, in order to determine whether the rollers are disengaged, a rotation sensor assembly may be provided between the outer race and the inner race for detecting relative rotation between the outer race and the inner race.

With this arrangement, when the rollers are supposed to be disengaged due to energization or deenergization of the electromagnet, if the rollers are actually not disengaged due to residual torque, the input shaft and the output shaft rotate at the same speed, so that no rotation signal is generated from the rotation sensor.

On the other hand, if the rollers are actually disengaged, a rotation signal is generated from the rotation sensor because the input shaft and the output shaft rotate relative to each other. Thus, depending on whether a signal is being generated from the rotation sensor, it is possible to reliably determine whether or not the rollers have been disengaged.

The rotation transmission device may include a bearing supporting the outer race and the inner race so as to be rotatable relative to each other and carrying the rotation sensor assembly. With this arrangement, it is possible to mount the rotation sensor assembly simultaneously when mounting the bearing. Thus, the rotation transmission device can be assembled easily.

In order to determine whether the rollers are disengaged, a gap sensor may be provided for detecting the size of the gap between the armature and the rotor.

With this arrangement, when the rollers are supposed to be disengaged due to energization or deenergization of the electromagnet, if the rollers are actually not disengaged due to residual torque, a large gap exists between the rotor and the armature, so that no signal is generated from the gap sensor. If the rollers are disengaged, the gap between the rotor and the armature disappears, or only a small gap remains therebetween. Thus, a signal is generated from the gap sensor.

Thus, depending on whether a signal is being generated from the gap sensor, it is possible to determine whether or not the rollers have been disengaged.

The size of the gap between the armature and the rotor is inversely proportional to the magnetic attraction force of the electromagnetic clutch. The magnetic attraction force of the electromagnetic clutch is proportional to the magnetic flux. Thus, it is possible to determine the size of the gap between the armature and the rotor from changes in magnetic flux.

A magnetic flux is ordinarily detectable using a search coil. Thus, a search coil can be used as the gap sensor. In particular, the search coil may be mounted in the electromagnet so that when the armature is pulled to the rotor and the rollers are disengaged, a predetermined electric current is generated from the search coil. With this arrangement, it is possible to determine whether the rollers are disengaged based on the intensity of the current generated from the search coil.

### ADVANTAGES OF THE INVENTION

According to the present invention, when the control retainer is moved in the direction in which the flange of the control retainer moves away from the flange of the rotary flange, the control retainer and the rotary retainer rotate relative to each other in the direction in which the circumferential width of the pockets increases under the biasing force of the presser members, so that the opposed pairs of rollers instantly wedge into the respective narrow ends of the wedge-shaped spaces. This minimizes play in the rotation direction of the rotation transmission device.

Since the opposed pairs of rollers are biased away from each other, while being pressed against the outer periphery of the inner race, by the presser members, the rollers never erroneously engage while the two-way roller clutch is idling. This improves reliability of the operation during idling, and minimizes idling torque.

Since torque is transmitted between the outer race and the inner race through as many rollers as the number of the cam surfaces, the rotation transmission device has a large torque capacity.

### BRIEF DESCRIPTION OF THE DRAWINGS

FIG. 1 is a vertical sectional front view of a rotation transmission device embodying the present invention.

FIG. 2(I) is a sectional view taken along line II-II of FIG. 1; and FIG. 2(II) is a sectional view showing the state in which rollers are in disengagement.

FIG. 3 is a partial plan view of a retainer of a two-way roller clutch.

FIG. 4 is a sectional view taken along line IV-IV of FIG. 1.

FIG. 5(I) is a plan view of a torque cam while in engagement; FIG. 5(II) is its plan view while in disengagement; and FIG. 5(III) is a partial enlarged sectional view of FIG. 5(I).

FIG. 6 is a sectional view of a different presser member.

FIG. 7 is a sectional view of a bearing with a rotation sensor assembly.

FIG. 8 is a sectional view of a different means for determining whether the rollers are disengaged.

FIG. 9 is a sectional view of a still different means for determining whether the rollers are disengaged.

FIG. 10 is a vertical sectional front view of a different electromagnetic clutch as an actuator.

FIG. 11 is a sectional view of different cam surfaces.

### BEST MODE FOR EMBODYING THE INVENTION

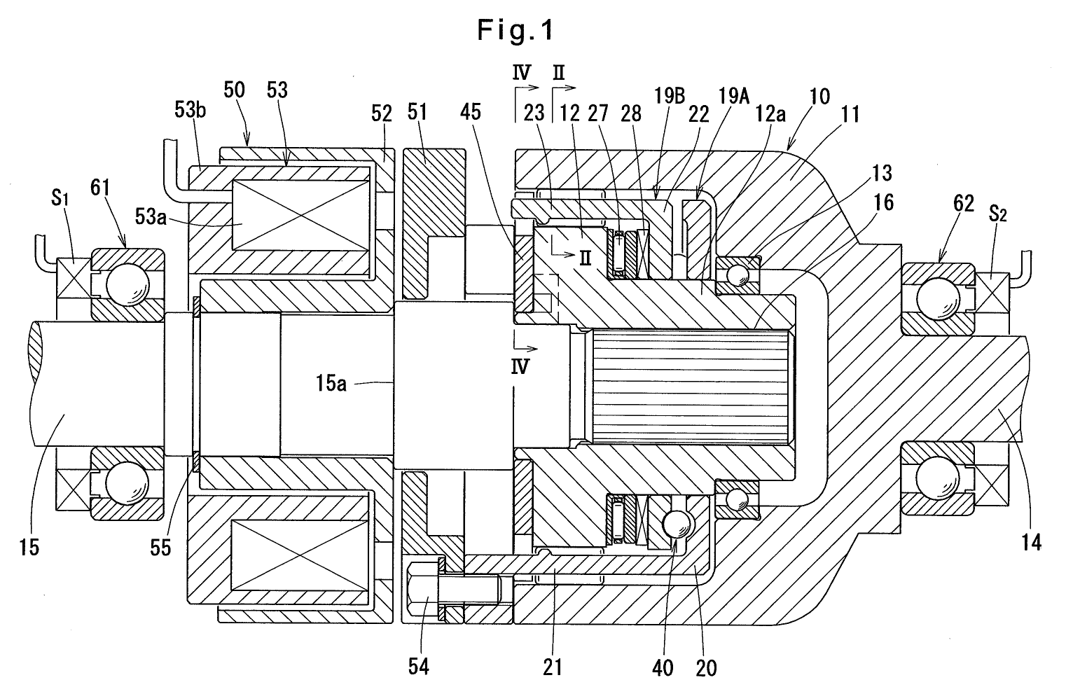

Now the embodiment of the present invention is described with reference to the drawings. FIG. 1 shows a rotation transmission device embodying the present invention. As shown, the rotation transmission device includes a two-way roller clutch 10.

The two-way roller clutch 10 includes an outer race 11 and an inner race 12 mounted inside the outer race 11. The inner race 12 has a boss portion 12a on which a bearing 13 is fitted. Through the bearing 13, the outer race 11 and the inner race 12 are rotatable relative to each other.

The outer race 11 has a closed end which is formed with an output shaft 14. An input shaft 15 as a torque transmission shaft has one end thereof inserted in the inner race 12. The portion of the input shaft 15 inserted in the inner race 11 is formed with serrations 16 through which the inner race 12 and the input shaft 15 are rotationally fixed to each other.

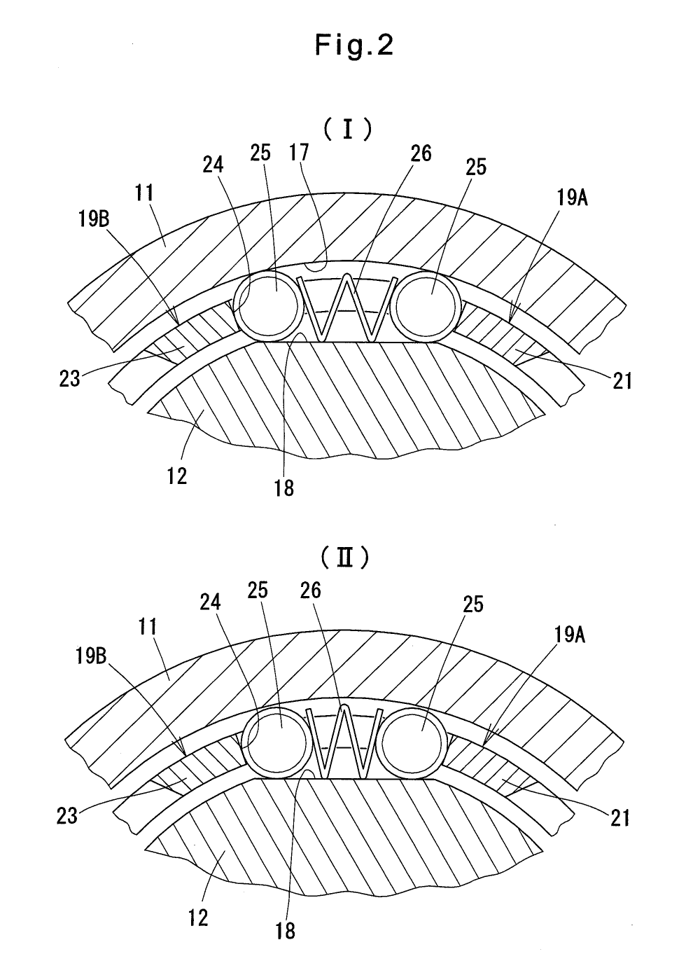

As shown in FIGS. 2(I) and 2(II), the outer race 11 has a cylindrical surface 17 on its inner periphery, while the inner race 11 has on its outer periphery a plurality of circumferentially equidistantly spaced apart flat cam surfaces 18 each defining a wedge-shaped space which narrows toward both circumferential ends, in cooperation with the cylindrical surface 17.

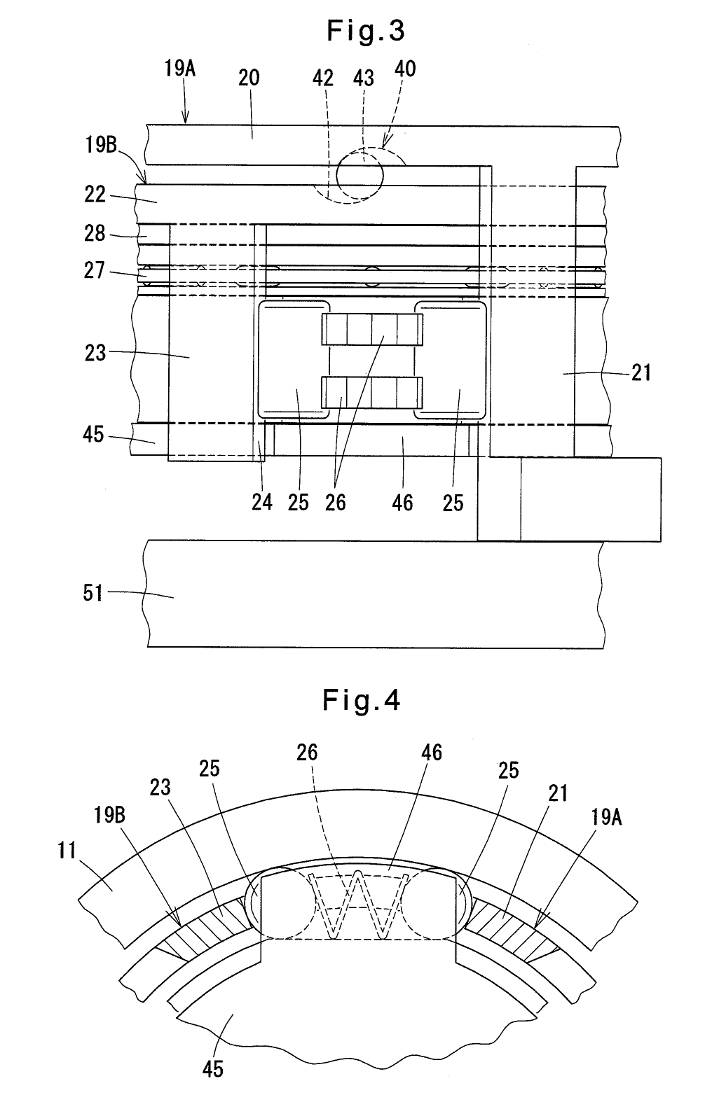

A control retainer 19A and a rotary retainer 19B are mounted between the outer race 11 and the inner race 12. As shown in FIGS. 1 and 3, the control retainer 19A comprises a flange 20 and as many pillars 21 as the number of the cam surfaces 18 provided on the radially outer portion of the flange 20 so as to be circumferentially equidistantly spaced apart from each other. Similarly, the rotary retainer 19B comprises a flange 22 and as many pillars 23 as the number of the cam surfaces 19 provided on the radially outer portion of the flange 22 so as to circumferentially equidistantly spaced apart from each other.

The rotary retainer 19B has its flange 22 fitted on the boss portion 12a of the inner race 12 and its pillars 23 disposed between the cylindrical surface 17 and the respective cam surfaces 18, with the flange 22 facing one side surface of the inner race 12.

The control retainer 19A has its flange 20 fitted on the boss portion 12a of the inner race 12 so as to axially face the flange 22 of the rotary retainer 19B, and its pillars 21 disposed between the respective adjacent pillars 23 of the rotary retainer 19B.

With the retainers 19A and 19B mounted in position in this manner, as shown in FIGS. 2(I) and 3, a pocket 24 is defined between each pillar 21 of the control retainer 19A and the corresponding pillar 23 of the rotary retainer 19B. The pockets 24 radially face the respective cam surfaces 18 of the inner race 12 and each accommodate an opposed pair of rollers 25 and a presser member 26 biasing the pair of rollers 25 away from each other while pressing them against the cam surface 18 of the inner race 12.

The presser member 26 of the embodiment is a leaf spring bent in the shape of the letter W and arranged such that the rollers 25 are obliquely pressed toward the respective circumferential ends of the cam surface 18 by its bent pieces at both ends, respectively.

A single presser member 26 is arranged so as to press the longitudinal central portion of each roller 25. But instead, a plurality of such presser members 26 may be arranged in a plurality of rows in the longitudinal direction of the rollers 25 to prevent skew of the rollers 25.

As shown in FIG. 1, the rotary retainer 19B is rotatable about the boss portion 12a of the inner race 12. Between the flange 22 of the rotary retainer 19B and the one side surface of the inner race 12, a thrust needle bearing 27 and an elastic member 28 for biasing the flange 22 of the rotary retainer 19B toward the flange 20 of the control retainer 19A are mounted.

The elastic member 28 is a coil spring coaxial with the inner race 12. But instead, a plurality of spring members may be used that are arranged along an imaginary circle of which the center is located on the axis of the inner race 12.

The control retainer 19A is rotatable about the boss portion 12a of the inner member 12, and is axially movable.

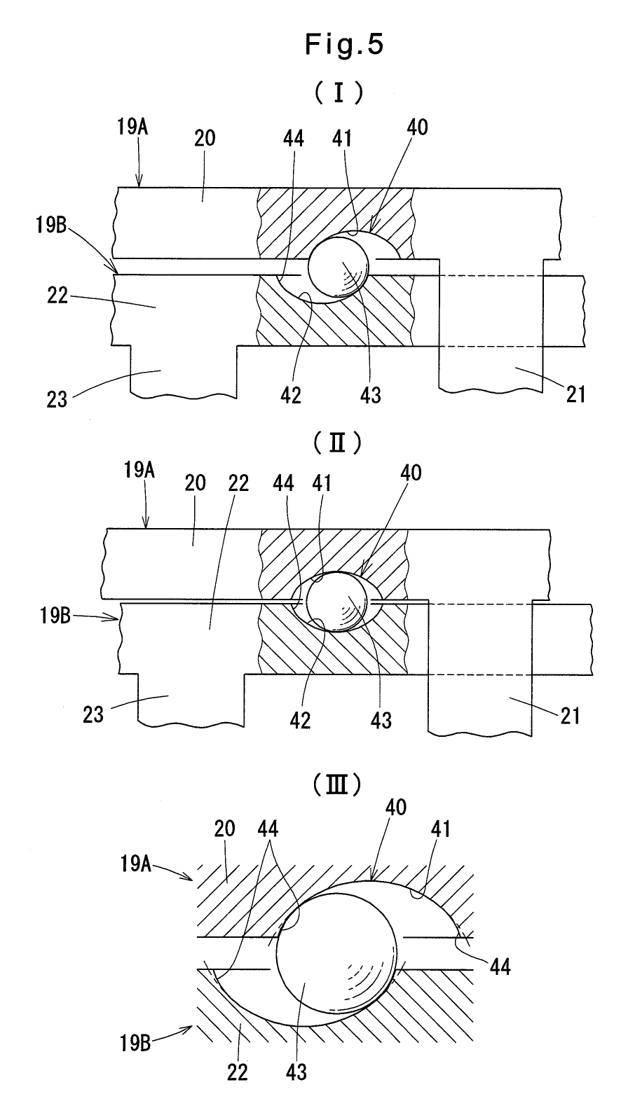

As shown in FIG. 5(I), torque cams 40 are provided between the flange 20 of the control retainer 19A and the flange 22 of the rotary retainer 19B. Each torque cam 40 comprises an opposed pair of cam grooves 41 and 42 which each gradually shallow from the deepest circumferential central portion toward the circumferential ends, and a ball 43 disposed between one and the other circumferential ends of the respective cam grooves 41 and 42.

The cam grooves 41 and 42 shown are arcuate ones. But instead, V-shaped grooves may be used. As shown in FIG. 5(III), the cam grooves 41 and 42 have, at their circumferential ends, spherical stopper surfaces 44 extending along the outer periphery of the ball 43.

When the control retainer 19A moves axially in the direction in which its flange 20 moves toward the flange 22 of the rotary flange 22 of the rotary retainer 19B, the ball 43 of each torque cam 40 rolls toward the deepest portions of the cam grooves 41 and 42 as shown in FIG. 5(II), thus allowing the control retainer 19A and the rotary retainer 19B to rotate relative to each other in the direction in which the circumferential width of the pockets 24 decreases.

As shown in FIGS. 1, 3 and 4, a retaining plate 45 is fixed to the other side surface of the inner race 12. The retaining plate 45 is an annular plate having a plurality of anti-rotation pieces 46 formed on the radially outer surface thereof and located in the respective pockets 24 defined between the pillars 21 of the control retainer 19A and the pillars 23 of the rotary retainer 19B.

When the control retainer 19A and the rotary retainer 19B rotate relative to each other in the direction in which the circumferential width of the pockets 24 decreases, the pillars 21 of the control retainer 19A and the pillars 23 of the rotary retainer 19B are supported by the respective side edges of the plurality of anti-rotation pieces 46, so that the opposed pairs of rollers 25 are kept in neutral position.

As shown in FIG. 1, on one axial side of the two-way roller clutch 10, an electromagnetic clutch 50 as an actuator for axially moving the control solenoid 19A is provided.

The electromagnetic clutch 50 comprises an armature 51 axially facing the end surfaces of the pillars 21 of the control retainer 19A, a rotor 52 axially facing the armature 51, and an electromagnet 53 axially facing the rotor 52.

The armature 51 is fitted on and rotatably supported by the input shaft 15, and is fixedly coupled to the pillars 21 of the control retainer 19A by tightening bolts 54 threaded into the end surfaces of the respective pillars 21.

The rotor 52 is fitted on the input shaft 15 so as to be axially held in position by a shoulder 15a formed on the outer periphery of the input shaft 15 and a snap ring 55 fitted on the outer periphery of the input shaft 15. The rotor 52 is also rotationally fixed to the input shaft 15.

The electromagnet 53 comprises an electromagnetic coil 53a and a core 53b supporting the electromagnetic coil 53a. The core 53b is supported by a stationary member, not shown.

Now the operation of the rotation transmission device of the embodiment is described. FIG. 1 shows the state in which the electromagnetic coil 53a of the electromagnet 53 is not energized. Thus in FIG. 1, the armature 51 is separated from the rotor 52. Further in this state, the two-way roller clutch 10 is in engagement, i.e. as shown in FIG. 2(I), the opposed pairs of rollers 25 of the two-way roller clutch 10 are in engagement with the cylindrical surface 17 of the outer race 11 and the respective cam surfaces 18 of the inner race 12.

With the two-way roller clutch 10 in engagement, when the electromagnetic coil 53a is energized, the armature 51 is moved axially and pulled to the rotor 52 under magnetic attraction force that acts on the armature 51.

Since the armature 51 is fixedly coupled to the pillars 21 of the control retainer 19A, when the armature 51 is moved axially, the control retainer 19A is moved in the direction in which its flange 20 moves toward the flange 22 of the rotary retainer 19B.

In this state, as shown in FIG. 5(II), the ball 43 of each torque cam rolls toward the deepest portions of the cam grooves 41 and 42, and thus the control retainer 19A and the rotary retainer 19B rotate relative to each other in the direction in which the circumferential width of the pockets 24 decreases. Thus, as shown in FIG. 3, each opposed pair of rollers 25 are pushed by the pillar 21 of the control retainer 19A and the pillar 23 of the rotary retainer 19B, respectively, and disengage as shown in FIG. 2(II). The two-way roller clutch 10 thus disengages.

With the two-way roller clutch 10 disengaged, when torque is applied to the input shaft 15 and the inner race 12 is rotated in one direction, the anti-rotation pieces 46 of the retaining plate 45 press the pillars 21 of the control retainer 19A or the pillars 23 of the rotary retainer 19B, thus rotating the control retainer 19A and the rotary retainer 19B together with the inner race 12. In this state, since the opposed pair of rollers 25 are kept in disengaged neutral position, the rotation of the inner race 12 is not transmitted to the outer race 11 and the inner race 12 rotates alone.

In this way, when the control retainer 19A is moved in the direction in which its flange 20 moves toward the flange 22 of the rotary retainer 19B, the opposed pairs of rollers 25 are pushed by the respective pillars 21 and 23 of the control retainer 19A and the rotary retainer 19B, and disengage. In this state, since the opposed pairs of rollers 25 are prevented from being moved into the narrow portions of the respective wedge-shaped spaces by the pillars 21 and 23 of the control retainer 19A and the rotary retainer 19B, the rollers 25 never erroneously engage while the two-way roller clutch 10 is idling.

Since each opposed pair of rollers 25 are always pressed against the cam surface 18 of the inner race 12 by the presser member 26 comprising a leaf spring in the shape of the letter W, the rollers 25 never move radially outwardly under centrifugal force.

If the rollers 25 should move radially outwardly under centrifugal force, the rollers 25 may contact the cylindrical surface 17 of the outer race 11, which could result in dragging torque acting on the rollers 25, thereby moving the rollers to engaged position. But in the arrangement of the present invention, since the presser members 26 prevent radially outward movement of the rollers, the rollers 25 never erroneously engage.

Since the rollers 25 rotate without contacting the cylindrical surface 17 of the outer race 25, the rollers never increase idling torque.

When the control retainer 19A and the rotary retainer 19B rotate relative to each other in the direction in which the circumferential width of the pockets 24 decreases, the pillars 21 of the control retainer 19A and the pillars 23 of the rotary retainer 19B abut the respective side edges of the anti-rotation pieces 46 of the retaining plate 45, thereby restricting the distance of the relative rotation.

This prevents the presser members 26 from being compressed more than necessary, thus preventing fatigue breakage of the presser members even after they are repeatedly expanded and compressed.

With the inner race 12 idling, when the electromagnetic coil 53a is deenergized, the attraction force applied to the armature 51 disappears, so that the armature 51 becomes rotatable, and the control retainer 19A and the rotary retainer 19B rotate relative to each other in the direction in which the circumferential width of the pockets 24 increases. Thus, the opposed pairs of rollers 25 instantly wedge into the respective narrow portions of the wedge-shaped spaces, and torque is transmitted between the inner race 12 and the outer race 11 in one direction through one of each opposed pair of rollers 25.

When the input shaft 15 is stopped in this state, and is rotated in the opposite direction, the rotation of the inner race 12 is transmitted to the outer race 11 through the other of each opposed pair of rollers 25.

Since by deenergizing the electromagnetic coil 53a, the control retainer 19A and the rotary retainer 19B rotate relative to each other in the direction in which the circumferential width of the pockets 24 increases, and the opposed pairs of rollers 25 instantly wedge into the respective narrow portions of the wedge-shaped spaces, it is possible to instantly transmit the rotation of the inner race 12 to the outer race 11 while minimizing play in the rotational direction.

Since torque is transmitted from the inner race 12 to the outer race 11 through as many rollers 25 as the number of the cam surfaces 18, it is possible to transmit large torque from the inner race 12 to the outer race 11.

When the control retainer 19A and the rotary retainer 19B rotates relative to each other in the direction in which the circumferential width of the pockets 24 increases, the ball 43 of each torque cam rolls toward shallow ends of the respective opposed pair of cam grooves 41 and 42, as shown in FIG. 5(I).

At this time, if the control retainer 19A and the rotary retainer 19B rotate relative to each other with their axes inclined to each other, the distances between the cam grooves 41 and 42 of the respective torque cams differ from each other, so that loads applied to the respective balls 43 also differ from each other. In this state, any ball 43 to which load is scarcely or not at all applied may circumferentially come out of the cam grooves 41 and 42 from their shallow portions. If this happens, the two-way roller clutch 10 does not reliably operate any more.

But in the arrangement of the present invention, since the elastic member 28 is mounted between the opposed surfaces of the flange 22 of the rotary retainer 19B and the inner race 12 to bias the flange 22 of the rotary retainer 19B toward the flange 20 of the control retainer 19A, the control retainer 19A and the rotary retainer 19B are always kept coaxial with each other.

Thus, loads are uniformly applied to the respective balls 43, which prevents separation of the balls 43 while the control retainer 19A and the rotary retainer 19B are rotating relative to each other, which in turn allows normal operation of the two-way roller clutch 10 at all times.

As shown in FIG. 5(III), by providing the spherical stopper surfaces at the shallow ends of the cam grooves 41 and 42 so as to extend along the outer periphery of the ball 43, it is possible to more reliably prevent separation of the ball 43.

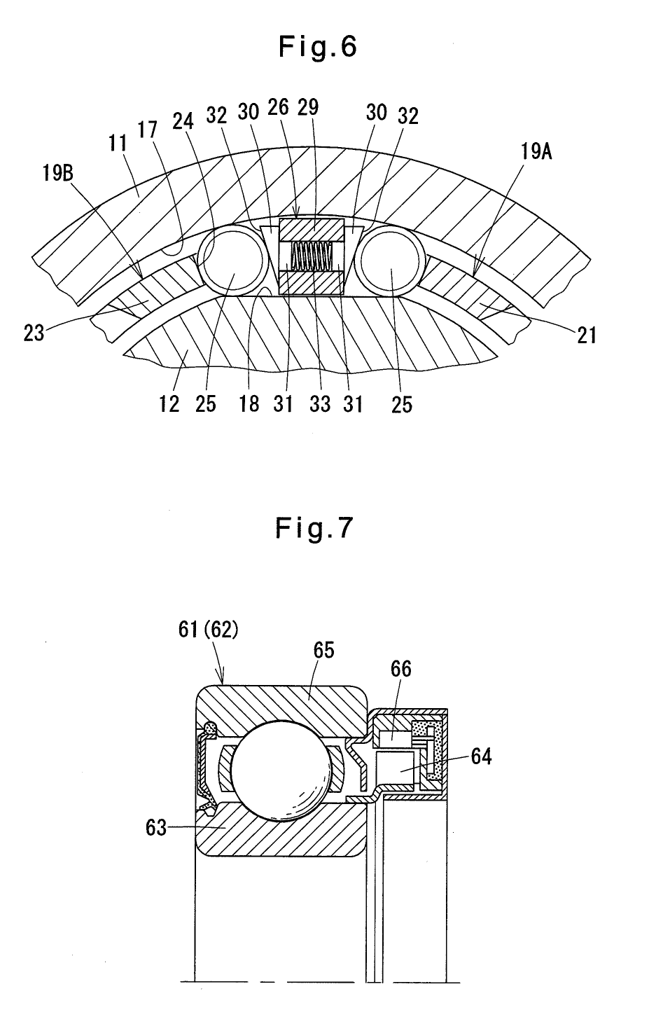

The presser member 26 shown in FIG. 2 comprises a leaf spring in the shape of the letter W. But the presser member 26 is not limited thereto. FIG. 6 shows a different presser member 26, which comprises a cylindrical member 29, a pair of presser elements 30 each having a pin 31 slidably inserted in one end of the cylindrical member 29, and a coil spring 33 biasing the presser elements 30 in the directions to protrude from the cylindrical member 29. The presser elements 30 each have a roller pressing surface 32 in the form of an inclined surface that presses the corresponding roller 25 toward the circumferential end of the cam surface 18 of the inner race 12.

When the electromagnetic coil 53a is energized in order to disengage the rollers 25 by attracting the armature 51, if there remains torque between the inner race 12 and the outer race 11, the residual torque may prevent disengagement of the rollers 25.

This makes it impossible to determine whether the rollers 25 are in engagement or engagement only from the fact that the electromagnetic coil 53a of the electromagnetic clutch 50 is energized or deenergized.

In order to reliably determine whether or not the rollers are disengaged, in FIG. 1, the input shaft 15 is rotatably supported by a first bearing 61 carrying a first rotation sensor assembly S₁, and the output shaft 14 is rotatably supported by a second bearing 62 carrying a second rotation sensor assembly S₂.

As shown in FIG. 7, each of the sensor assemblies S₁ and S₂ comprises a magnetic encoder 64 mounted to the rotary bearing race 63 of the first bearing 61 or the second bearing 62, and a magnetic sensor 66 mounted to the stationary bearing race 65 of the first bearing 61 or the second bearing 62 for generating a rotation signal due to changes in magnetic flux generated from the magnetic encoder 64 when the encoder 64 rotates.

The magnetic sensor 66 of the embodiment is a Hall IC.

By rotatably supporting the input shaft 15 with the first bearing 61 carrying the first rotation sensor assembly S₁ and rotatably supporting the output shaft 14 with the second bearing 62 carrying the second rotation sensor assembly S₂, when the electromagnetic coil 53a is energized and thus the rollers 25 are supposed to be disengaged, if the rollers 25 are actually not disengaged due to residual torque, the input shaft 15 and the output shaft 14 rotate at the same speed, so that identical rotation signals are generated from the magnetic sensor 66 of the first rotation sensor assembly S₁ and the magnetic sensor 66 of the second rotation sensor assembly S₂.

On the other hand, if the rollers 25 are actually disengaged, since only the input shaft 15 keeps rotating while the output shaft 14 stops, a rotation signal is generated from the magnetic sensor 66 of the first rotation sensor assembly S₁, while no rotation signal is generated from the magnetic sensor 66 of the second rotation sensor assembly S₂.

Thus, depending on whether there is a difference between the rotation signal generated from the magnetic sensor 66 of the first rotation sensor assembly S₁ and the rotation signal generated from the magnetic sensor 66 of the second rotation sensor assembly S₂, it is possible to reliably determine whether or not the rollers 25 have been disengaged.

In FIG. 1, rotations of the input shaft 15 and the output shaft 14 are detected by rotation sensor assemblies mounted to the respective bearings. But instead, the rotations of the input shaft 14 and the output shaft 15 may be detected using encoders mounted to the input shaft 15 and the output shaft 14, respectively, and magnetic sensors provided around the respective encoders.

As shown in FIG. 1, by using the bearings each carrying a sensor assembly to detect the rotations of the input shaft and the output shaft, it is possible to mount the first rotation sensor assembly and the second rotation sensor assembly simultaneously when mounting the first bearing 61 and the second bearing 62. Thus, the rotation transmission device can be assembled easily.

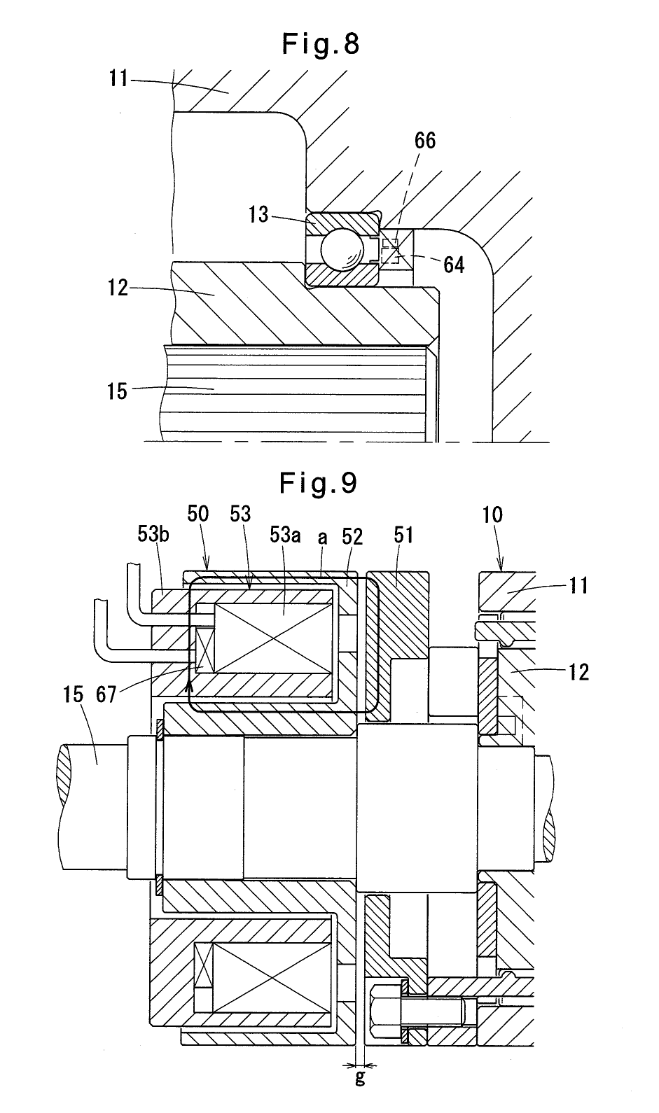

FIG. 8 shows a different determining means for determining whether or not the rollers 25 have been disengaged when the electromagnetic coil 53a is energized and the armature 51 is pulled to the rotor 52, as shown in FIG. 1. This means comprises a bearing 13 supporting the outer race 11 and the inner race 12 so as to be rotatable relative to each other. This bearing 13 is the bearing with a rotation sensor assembly shown in FIG. 7. Thus, when the outer race 11 and the inner race 12 rotate relative to each other, a relative rotation signal is generated from the magnetic sensor 66 of the rotation sensor.

In this arrangement, when the electromagnetic coil 53a is energized and the rollers 25 tend to disengage, if the rollers 25 do not actually disengage, no relative rotation signal is generated from the magnetic sensor 66 because the input shaft 15 and the output shaft 14 are rotating at the same speed in this state.

On the other hand, if the rollers are actually disengaged, since the input shaft 15 and the output shaft 14 rotate relative to each other, a relative rotation signal is generated from the magnetic sensor 66. Thus, depending on whether a relative rotation signal is being generated from the magnetic sensor 66, it is possible to reliably determine whether or not the rollers 25 have been disengaged.

In the arrangement of FIG. 8, since the magnetic sensor 66 rotates in unison with the outer race 11, a rotation signal is read from the magnetic sensor 66 using a slip ring. In FIG. 8, a bearing carrying a rotation sensor assembly is used to determine whether the rollers 25 are disengaged. But instead, in order to determine whether the rollers 25 are disengaged, an encoder may be mounted to the radially outer surface of the inner race 12 and a magnetic sensor may be mounted to the radially inner surface of the outer race 11.

In the rotation transmission device of FIG. 1, when the electromagnetic coil 53a is energized to disengage the rollers 25, due to a magnetic flux a that flows through the armature 51, rotor 52 and core 53b, as shown in FIG. 9, a magnetic attraction force acts on the armature 51, thus pulling the armature 51 to the rotor 52. Thus, a gap g between the armature 51 and the rotor 52 is supposed to disappears, and the rollers 25 are supposed to disengage.

But if the rollers 25 are actually not disengaged in this state, a large gap g remains between the rotor 52 and the armature 51.

Thus, it is possible to determine whether the rollers 25 have been disengaged by measuring the size of the gap g between the armature 51 and the rotor 52.

The size of the gap g between the armature 51 and the rotor 51 is inversely proportional to the magnetic attraction force of the electromagnetic clutch 50. The magnetic attraction force of the electromagnetic clutch 50 is proportional to the magnetic flux. Thus, it is possible to determine the size of the gap g between the armature 51 and the rotor 52 from changes in magnetic flux.

A magnetic flux is ordinarily detectable using a search coil. In the arrangement of FIG. 9, a search coil 67 is mounted in the core 53b. The search coil 67 generates a large electric current when the electromagnetic coil 53a is energized and the magnetic flux changes as a result of the armature 51 being pulled to the rotor 52.

Thus, it is possible to determine whether the rollers 25 are disengaged depending on the intensity of the current generated from the search coil 67 mounted in the core 53b.

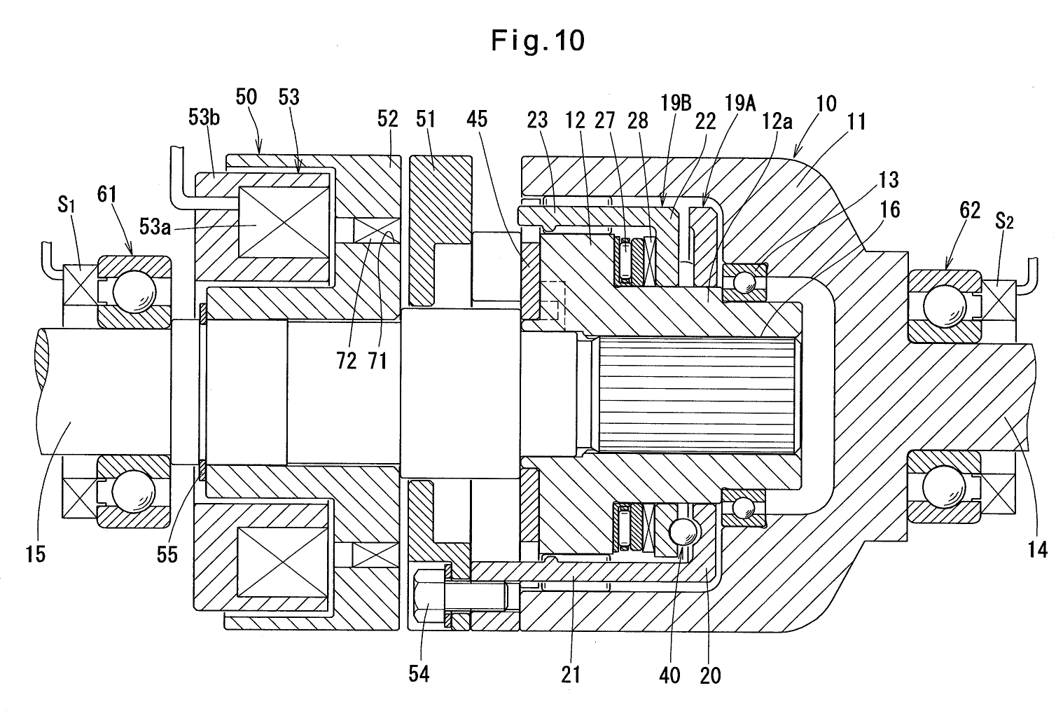

FIG. 10 shows a different electromagnetic clutch 50 as an actuator. This electromagnetic clutch 50 differs from the electromagnetic clutch 50 shown in FIG. 1 in that arcuate slits 71 are formed in the surface of the rotor 51 facing the armature 51 and permanent magnets 72 are received in the respective slits 71. Elements identical or corresponding to the electromagnetic clutch 50 of FIG. 1 are denoted by identical numerals and their description is omitted.

With this electromagnetic clutch 50, while the electromagnetic coil 53a of the electromagnet 53 is not energized, the armature 51 is pulled toward the rotor 52 under the magnetic force of the permanent magnets 72. When the electromagnetic coil 53a is energized, the magnetic force of the permanent magnets 72 is reduced to a level lower than the biasing force of the presser members 26 disposed between the respective opposed pairs of rollers 25, so that the armature 51 moves away from the rotor 52 under the biasing force of the presser members 26.

When the armature 51 is moved by energizing and deenergizing the electromagnet 53, the control retainer 19A, which is fixedly coupled to the armature 51, is axially moved. When the control retainer 19A is moved in the direction in which its flange 20 moves toward the flange 22 of the rotary retainer 19B, the control retainer 19A and the rotary retainer 19B rotate relative to each other in the direction in which the circumferential width of the pockets 24 decreases under the action of the torque cams 40. As a result, the opposed pairs of rollers 25 are pushed by the respective pillars 21 and 23 of the control retainer 19A and the rotary retainer 19B and disengage.

When the control retainer 19A is moved in the direction in which its flange 20 moves away from the flange 22 of the rotary retainer 19B, the control retainer 19A and the rotary retainer 19B rotate relative to each other in the direction in which the circumferential width of the pockets 24 increases under the biasing force of the presser members 26. As a result, the opposed pairs of rollers 25 instantly wedge into the respective narrow ends of the wedge-shaped spaces.

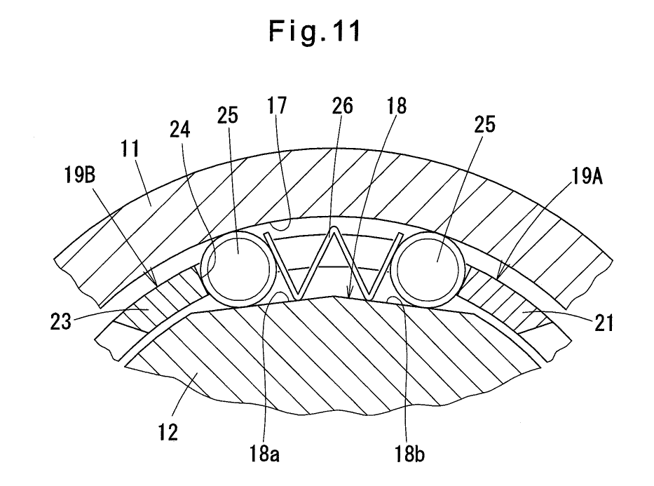

In the arrangement of FIG. 2, cam surfaces 18 comprising flat surfaces are formed on the inner race 12. But different cam surfaces 18 may be used. For example, cam surfaces 18 shown in FIG. 11 may be used, which each comprise two inclined surfaces 18a and 18b inclined in opposite directions to each other. In this case, each opposed pair of rollers 25 are mounted in the corresponding pocket 24 such that one of the rollers 25 faces the inclined surface 18a and the other faces the other inclined surface 18b.

In the arrangement of FIG. 2, the cylindrical surface 17 is formed on the inner periphery of the outer race 11 and the cam surfaces 18 are formed on the outer periphery of the inner race 12. But instead, the cam surfaces may be formed on the inner periphery of the outer race 11 and the cylindrical surface may be formed on the outer periphery of the inner race 12.

### DESCRIPTION OF THE NUMERALS

10. Two-way roller clutch
11. Outer race
12. Inner race
14. Output shaft
15. Input shaft (Torque transmission shaft)
17. Cylindrical surface
18. Cam surface
19A. Control retainer
19B. Rotary retainer
20. Flange
21. Pillar
22. Flange
23. Pillar
24. Pocket
25. Roller
26. Presser member
27. Thrust needle bearing
28. Elastic member
29. Cylindrical member
30. Presser element
32. Roller pressing surface
33. Coil spring
40. Torque cam
41. Cam groove
42. Cam groove
43. Ball
44. Stopper surface
45. Retaining plate
46. Anti-rotation piece
50. Electromagnetic clutch (Actuator)
51. Armature
52. Rotor
53. Electromagnet
61. First bearing
62. Second bearing
64. Electromagnetic encoder
66. Magnetic sensor
67. Search coil
71. Slit
72. Permanent magnet
S₁. First rotation sensor assembly
S₂. Second rotation sensor assembly

1. A rotation transmission device comprising an outer race having a closed end provided with an output shaft, an input shaft, an inner race mounted on the input shaft and in the outer race, said outer race and said inner race being rotatable relative to each other, wherein a cylindrical surface is formed on one of an inner periphery of the outer race and an outer periphery of the inner race, and a plurality of circumferentially spaced apart cam surfaces are formed on the other of the inner periphery of the outer race and the outer periphery of the inner race, said cylindrical surface and each of said cam surfaces defining a wedge-shaped space therebetween which narrows toward circumferential ends thereof, a control retainer and a rotary retainer rotatably mounted between the outer race and the inner race, wherein said control retainer comprises a flange and a plurality of pillars formed on a radially outer portion the flange, wherein the rotary retainer has the same shape as the control retainer, wherein the flanges of the respective retainers axially face each other, and wherein the flange of the rotary retainer faces one side surface of the inner race, with the pillars of one of the retainers disposed between the respective circumferentially adjacent pillars of the other of the retainers, thereby defining pockets between the respective circumferentially adjacent pillars of the respective retainers, said pockets facing the respective cam surfaces, a plurality of opposed pairs of rollers, each pair being received in one of the pockets, presser members received in the respective pockets and biasing the respective pairs of rollers away from each other while pressing the rollers against the outer periphery of the inner race, torque cams provided between opposed surfaces of the flange of the control retainer and the flange of the rotary retainer that are configured to rotate the retainers relative to each other in a direction in which a circumferential width of said pockets decreases when the control retainer moves in a direction in which the distance between the flange of the control retainer and the flange of the rotary retainer decreases, a retaining plate fixed to another side surface of the inner race and having a plurality of anti-rotation pieces on an outer periphery thereof for supporting the respective pillars of the retainers, thereby keeping the respective opposed pairs of rollers in neutral position, when the control retainer and the rotary retainer rotate relative to each other in the direction in which the circumferential width of the pockets decreases, and an actuator mounted on a torque transmission shaft connected to the inner race for axially moving the control retainer.

2. The rotation transmission device of claim 1 wherein said presser members each comprise a leaf spring bent in the shape of a letter W.

3. The rotation transmission device of claim 1 wherein said presser members each comprise a cylindrical member, a pair of presser elements slidably supported by respective ends of the cylindrical member and having, respectively, inclined roller pressing surfaces facing the respective ones of each opposed pair of rollers, and a coil spring biasing the pair of presser elements against the respective ones of said each opposed pair of rollers.

4. The rotation transmission device of claim 1 wherein a plurality of said presser members are arranged in a plurality of rows in a longitudinal direction of the rollers, between each opposed pair of rollers.

5. The rotation transmission device of claim 1 wherein the torque cams each comprise an opposed pair of cam grooves formed in the respective opposed surfaces of the flange of the control retainer and the flange of the rotary retainer and circumferentially spaced from the cam grooves of the other toque cams, said cam grooves having a depth that decreases toward circumferential ends thereof, and a ball fitted in the opposed pair of cam grooves, said ball of each torque cam being configured to roll from shallow portions toward deep portions of the respective opposed pair of cam grooves, thereby rotating the retainers relative to each other in the direction in which the circumferential width of the pockets decreases, when the control retainer moves in the direction in which the distance between the flanges of the respective retainers decreases.

6. The rotation transmission device of claim 5 further comprising an elastic member disposed between opposed surfaces of the flange of the rotary retainer and the inner race for biasing the flange of the rotary retainer toward the flange of the control retainer.

7. The rotation transmission device of claim 5 wherein the opposed pair of cam grooves of each torque cam each have spherical stopper surfaces extending along the outer periphery of the ball at the respective shallow circumferential ends thereof

8. The rotation transmission device of claim 5 further comprising a thrust needle bearing disposed between opposed surfaces of the elastic member and the inner race.

9. The rotation transmission device of claim 1 wherein said actuator is an electromagnetic clutch comprising an armature fixedly coupled to the pillars of the control retainer and slidably fitted on the outer periphery of the torque transmission shaft, a rotor supported by the torque transmission shaft and axially facing the armature, and an electromagnet axially facing the rotor and configured to pull the armature to the rotor when energized.

10. The rotation transmission device of wherein said actuator is an electromagnetic clutch comprising an armature fixedly coupled to the pillars of the control retainer and slidably fitted on the outer periphery of the torque transmission shaft, a rotor supported by the torque transmission shaft and axially facing the armature, a permanent magnet for pulling the armature to the rotor against the biasing force of the presser members, and an electromagnet axially facing the rotor and configured to reduce the magnetic force of the permanent magnet to a level lower than the biasing force of the presser members.

11. The rotation transmission device of claim 9 further comprising a first rotation sensor assembly provided around the input shaft for detecting the rotation of the input shaft, and a second rotation sensor assembly provided around the output shaft for detecting the rotation of the output shaft, wherein when the rollers are supposed to be disengaged due to energization or deenergization of the electromagnet, determination is made whether the rollers are actually disengaged based on whether there is a difference in rotation between a rotation signal generated from the first rotation sensor assembly and a rotation signal generated from the second rotation sensor assembly.

12. The rotation transmission device of claim 11 further comprising a first bearing rotatably supporting the input shaft and carrying the first rotation sensor assembly and a second bearing rotatably supporting the output shaft and carrying the second rotation sensor assembly.

13. The rotation transmission device of claim 11 wherein each of the first rotation sensor assembly and the second rotation sensor assembly comprises a magnetic encoder and a Hall IC for detecting changes in magnetic field due to rotation of the magnetic encoder and generating a digital signal.

14. The rotation transmission device of claim 9 further comprising a rotation sensor assembly provided between the outer race and the inner race for detecting relative rotation between the outer race and the inner race.

15. The rotation transmission device of claim 14 further comprising a bearing supporting the outer race and the inner race so as to be rotatable relative to each other and carrying said rotation sensor assembly.

16. The rotation transmission device of claim 9 further comprising a gap sensor for detecting the size of the gap between the armature and the rotor, wherein determination is made whether the rollers are disengaged based on an output signal from the gap sensor.

17. The rotation transmission device of claim 16 wherein said gap sensor is a search coil mounted in the electromagnetic coil for detecting changes in magnetic flux.
